(19) United States
(12) Patent Application Publication
(10) Pub. No.: US 2005/0009464 A1
(43) Pub. Date: Jan. 13, 2005

(54) Payment object dispensing machine

(75) Inventors: Takao Nireki, Tokyo (JP); Katsunari Nishimura, Tokyo (JP); Tamotsu Sakai, Tokyo (JP); Asuka Ikeda, Tokyo (JP)

Correspondence Address: MCGINN & GIBB, PLLC, 8321 OLD COURTHOUSE ROAD, SUITE 200, VIENNA, VA, 22182-3817, US

(73) Assignee: Aruze Corp., Tokyo (JP)

(21) Appl. No.: 10/844,605

(22) Filed: May 13, 2004

(30) Foreign Application Priority Data
May 15, 2003 (JP) P2003-137850
Jun. 18, 2003 (JP) P2003-173741
Jul. 7, 2003 (JP) P2003-193024

(51) Int. Cl. G07D 9/00; G07D 1/00

(52) U.S. Cl. 453/57

(57) ABSTRACT

A coin dispensing machine includes: a bucket for storing a plurality of coins, a rotation disk being placed on the bottom of the bucket and formed with a plurality of openings for accepting the coins, a drive unit for dispensing the coins accepted in the openings sequentially by rotating the rotation disk, and an overload preventing device for preventing excessive load from being imposed on the drive unit.

### CROSS-REFERENCE TO THE RELATED APPLICATION(S)

This application is based upon and claims a priority from prior Japanese Patent Applications No. 2003-137850 filed on May 15, 2003, No. 2003-173741 filed on Jun. 18, 2003, and No. 2003-193024 filed on Jul. 7, 2003, the entire contents of which are incorporated herein by reference.

### BACKGROUND OF THE INVENTION

1. Field of the Invention

The present invention relates to a payment object dispensing machine including a bucket for storing payment objects (such as coins), the apparatus for dispensing the payment objects stored in the bucket one at a time.

2. Description of the Related Art

A coin dispensing machine in a related art generally includes a bucket for storing coins, a coin delivery section for dispensing coins one at a time from the bucket, and a base for supporting the bucket and the coin delivery section. In the coin dispensing machine in the related art, a rotation disk is placed on the lower face of the bucket for rotation. The rotation disk is formed with a plurality of openings capable of accepting coins in a loop.

On the back of the rotation disk, a coin delivery guide plate is fixed integrally with the rotation disk. The coin delivery guide plate is formed like a ratchet wheel and includes as many claws as the number of the openings of the rotation disk. A coin ejection slot includes a coin ejection section for dispensing coins one at a time.

The coin delivery guide plate moves a coin inside the claw in a direction away from the center direction of the rotation disk with rotation of the rotation disk. When the moved coin is positioned in the proximity of the coin ejection slot, the coin ejection section ejects the coin one at a time. The coin ejection section is provided with a sensor for detecting the ejected coin, and the coin dispensing machine counts the number of ejected coins based on the detection signal from the sensor.

The described coin dispensing machine in the related art is disclosed in JP-A-7-085333 and in JP-A-9-319908 (pages 4-6, FIG. 15).

### SUMMARY OF THE INVENTION

However, in the coin dispensing machine in the related art, the opening part of the bucket is formed so as to become smaller from the top to the bottom and thus the weight of the coins stored in the bucket is concentrated on the opening part of the rotation disk placed on the bottom of the bucket. It may occur that an irregular coin such is different from regular coins in diameter may be mixed in the opening part of the rotation disk. Thus, the coin dispensing machine in the related art may be clogged with the coin accepted in the opening of the rotation disk in the vicinity of the coin ejection section, causing the rotation disk to stop. When the rotation disk stops, there occurs a problem that load is imposed on the motor that rotates the rotation disk and overcurrent flows into the motor.

To solve this problem, when the rotation disk stops because of clogging with a coin, a detection signal is not input from the sensor after the expiration of a predetermined time and therefore the coin dispensing machine in the related art determines that clogging with a coin occurs, and stops rotation of the motor.

However, the coin dispensing machine does not determine that clogging with a coin occurs unless the predetermined time has elapsed. Thus, there occurs a problem that overcurrent flows into the motor for rotating the rotation disk until the predetermined time has elapsed, and the motor becomes degraded. Since a current higher than the rated current also flows at the startup time, the capacity of the apparatus power supply must be set large, also causing the power supply cost to increase.

Since driving the motor is stopped after stopping of the rotation disk is detected, a considerable time is taken by the time driving the motor stops after the rotation disk stops. Accordingly, there occurs a problem that load is continuously imposed on the motor until driving the motor stops. Thus, if material of low strength such as a molded article is adopted for the peripheral mechanism of the motor, the peripheral mechanism of the motor is easily broken because of the load.

To solve the problems, it is possible to idle the drive shaft of the motor by a torque limiter when the rotation disk stops because of clogging with a coin. Accordingly, when the rotation disk stops because of clogging with a coin, the drive shaft of the motor is idled by the mechanism, a great deal of load is prevented from being imposed on the motor, and overcurrent does not flow.

However, as the torque limiter is only provided, clogging with a coin cannot be released although overcurrent can be prevented from flowing into the motor. Specifically, since the torque limiter is disposed between the drive shaft of the motor and the rotation shaft of the rotation disk, when a predetermined load torque or more is imposed on the torque limiter because of clogging with a coin, if the motor is reversely rotated for releasing the clogging of a coin, the drive shaft of the motor is also idled and the clogging of a coin cannot appropriately be released.

It is therefore an object of the invention to provide a payment object dispensing machine that can prevent overcurrent from flowing into a motor even at the failure time of clogging with a payment object (such as a coin) or at the startup time.

It is another object of the invention to provide a payment object dispensing machine that can prevent excessive load from being imposed on a motor when a rotation disk stops because of clogging with a payment object, thereby preventing overcurrent from flowing into the motor.

It is still another object of the invention to provide a payment object dispensing machine that can prevent excessive load from being imposed on a motor when a rotation disk stops because of clogging with a payment object, thereby preventing overcurrent from flowing into the motor, and can also release the clogging with the payment object.

According to a first aspect of the invention, there is provided a payment object dispensing machine including: a bucket hat stores a plurality of payment objects; a rotation disk being laced on a bottom of the bucket and formed with a plurality of openings for accepting the payment objects; a drive unit that dispenses the payment objects accepted in the openings sequentially by rotating the rotation disk; and an overload preventing device that prevents excessive load from being imposed on the drive unit.

According to a second aspect of the invention, there is provided a payment object dispensing machine including: storage means for storing a plurality of payment objects; rotation disk means being placed on a bottom of the storage means and formed with a plurality of openings for accepting the payment objects; drive means for dispensing the payment objects accepted in the openings sequentially by rotating the rotation disk; and overload preventing means for preventing excessive load from being imposed on the drive means.

### BRIEF DESCRIPTION OF THE DRAWINGS

These and other objects and advantages of the present invention will be more fully apparent from the following detailed description taken in conjunction with the accompanying drawings, in which:

FIG. 1 is an external view to show a coin dispensing machine in a first embodiment of the invention;

FIG. 2 is a drawing to show a rotation disk and the peripheral mechanism of the rotation disk in the first embodiment of the invention;

FIG. 3 is a drawing to show the mechanism of a coin ejection section in the first embodiment of the invention;

FIG. 4 is a drawing to show the cross section of the coin dispensing machine in the first embodiment of the invention;

FIG. 5 is an exploded view in perspective of the main part of the coin dispensing machine in the first embodiment of the invention;

FIG. 6 is a block diagram to show the internal configuration of the coin dispensing machine in the first embodiment of the invention;

FIG. 7 is a drawing to show the relationship of the current to the time in the first embodiment of the invention;

FIG. 8 is a flowchart to show the operation of the coin dispensing machine in the first embodiment of the invention;

FIG. 9 is a drawing to show the cross section of a coin dispensing machine in a second embodiment of the invention;

FIG. 10 is a perspective view to show a state in which a torque limiter and a one-way clutch are built in a driven gear in the second embodiment of the invention;

FIG. 11 is a plan view to show a state in which the torque limiter and the one-way clutch are built in the driven gear in the second embodiment of the invention;

FIG. 12 is a drawing to show the cross sections of the torque limiter and the one-way clutch in the second embodiment of the invention;

FIGS. 13A and 13B are drawings to show the characteristics of current relative to the time when a rotation disk stops in the second embodiment of the invention;

FIGS. 14A and 14B are drawings to show the characteristics of current relative to the time when the rotation disk stops in the second embodiment of the invention;

FIG. 15 is a perspective view to show how a torque limiter and a one-way clutch are built in a driven gear in another embodiment of the invention; and

FIG. 16 is a plan view to show how the torque limiter and the one-way clutch are built in the driven gear in the embodiment of the invention in FIG. 15.

### DETAILED DESCRIPTION OF THE PREFERRED EMBODIMENTS

Referring now to the accompanying drawings, there are shown preferred embodiments of payment object dispensing machine according to the invention.

Although embodiments of “coin” dispensing machine will be discussed herein, the invention is not limited to the “coin” dispensing machine and can also be applied to any apparatus for dispensing (paying out, or ejecting) a payment object such as a medal, a token, or various game media used in a gaming machine.

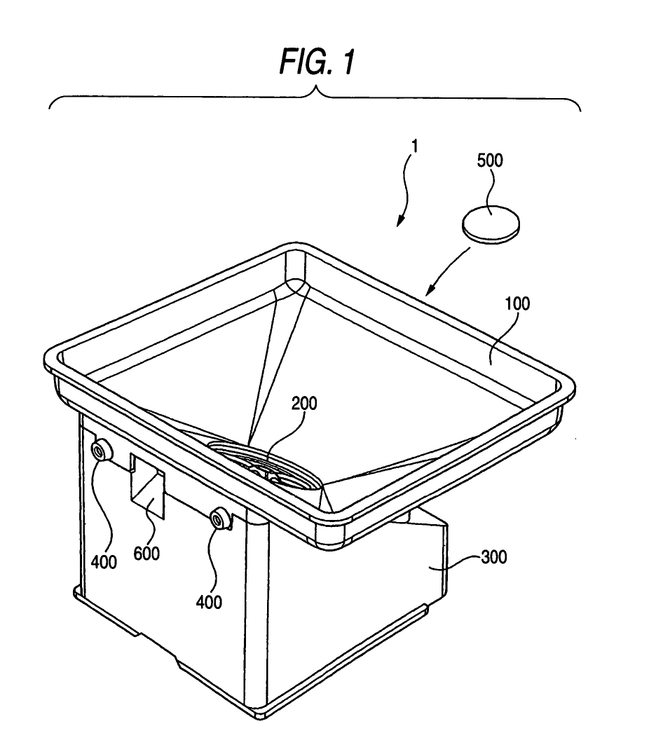

A coin dispensing machine 1 according to a first embodiment of the invention will be discussed with reference to the accompanying drawings. FIG. 1 is a perspective view to show one example of the coin dispensing machine 1.

As shown in FIG. 1, the coin dispensing machine 1 according to the embodiment includes a bucket 100, a rotation disk 200, and a base 300. The bucket 100 stores a plurality of coins 500. The bucket 100 is detachably attached to the base 300 via mounting screws 400.

The base 300 is implemented as a frame formed slantwise at a predetermined angle. The bucket 100, the rotation disk 200, and the like are disposed on the top of the base 300. A coin ejection opening 600 is an ejection port for ejecting the coin 500 accepted in an opening 211 of the rotation disk 200. The coin ejection opening 600 communicates with the inside of the bucket 100 in the rear.

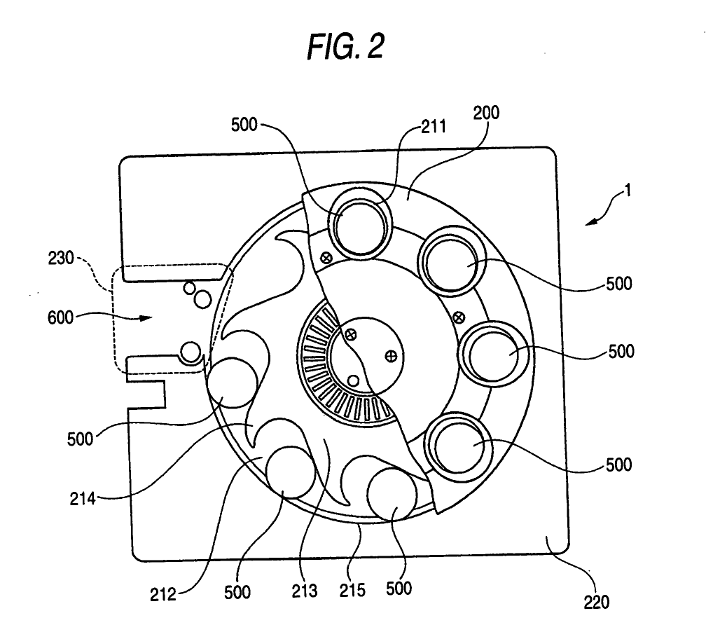

FIG. 2 is a drawing to show the structure of the rotation disk 200 and its periphery. As shown in FIG. 2, on the top, the rotation disk 200 driven by a motor 260 is attached. The rotation disk 200 is formed with, for example, about four to eight circular openings 211 at predetermined pitch like a ring. A circular coin reception plate 212 is attached to the lower face of the rotation disk 200.

A coin delivery guide plate 213 is fixed between the rotation disk 200 and the coin reception plate 212. The coin delivery guide plate 213 is formed like a ratchet wheel and has as many guide claws 214 as the number of the openings 211 made in the rotation disk 200. An outer guide plate 220 is attached to the surroundings of the rotation disk 200.

The outer guide plate 220 is formed in the center with a circular-ark-like coin guide face 215 having a little smaller than the diameter of the rotation disk 200. The coin 500 supported on the coin reception plate 212 through the opening 211 is retained on the guide claw 214 and is delivered in the direction away from the center shaft of the rotation disk 200 (in the direction in which it abuts the coin guide face 215) as the rotation disk 200 rotates.

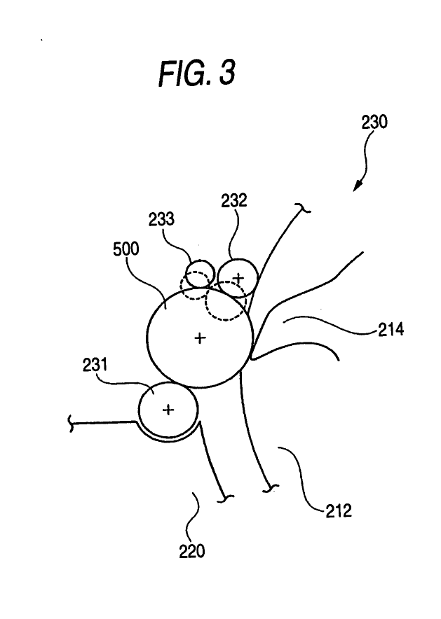

FIG. 3 is a drawing to show the mechanism of a coin ejection section 230. As shown in FIG. 3, the coin ejection section 230 includes a fixed roller 231, a moving roller 232, and an outer moving roller 233. The coin ejection section 230 is disposed in the proximity of the coin ejection opening 600.

The moving roller 232 and the outer moving roller 233 open and close the coin ejection opening 600 as they are pressed by the coin 500. The moving roller 232 and the outer moving roller 233 are urged in the direction of closing the coin ejection opening 600 by urging members such as coil springs.

As shown in FIG. 3, when the coin 500 arrives at the coin ejection opening 600, the coin 500 displaces, the positions of the moving roller 232 and the outer moving roller 233 (solid line portions shown in FIG. 3) as the guide claw 214 moves. The coin 500 displaces the position of the moving roller 232, whereby the coin ejection opening 600 can be placed in an open state. The state before the moving roller 232 and the outer moving roller 233 are displaced is indicated by the dotted lines in FIG. 3.

At the same time as the tip of the guide claw 214 comes in contact with the coin 500, the coin 500 is positioned climbing over the moving roller 232 and the outer moving roller 233. Accordingly, the coin 500 does not receive the pushing-out action of the guide claw 214 and is ejected with great force by the urging member of the moving roller 232.

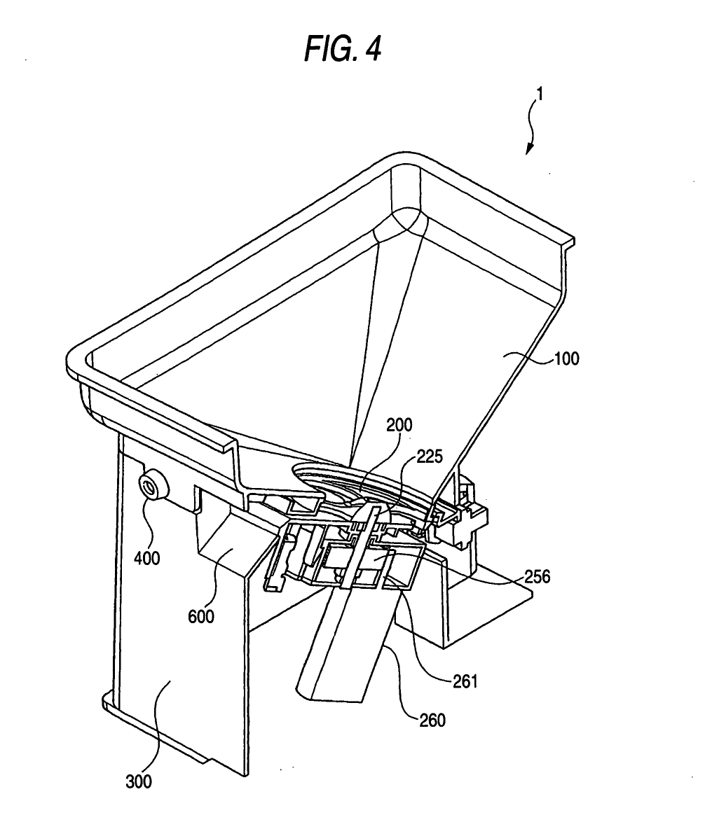

The peripheral mechanism of the rotation disk 200 will be described hereinafter. FIG. 4 is a schematic perspective view to show the cross section of the coin dispensing machine 1. As shown in FIG. 4, mainly disposed in the peripheral mechanism of the rotation disk 200 are a driven gear 256 including a rotation shaft 255 of the rotation disk 200 and a motor 260 including a drive gear 261 meshing with the driven gear 256.

As the motor 260 is driven, rotation of the drive gear 261 is transmitted to the driven gear 256, which then rotates the rotation disk, 200 via the rotation shaft 255. The details of the peripheral mechanism of the rotation disk 200 will be described hereinafter.

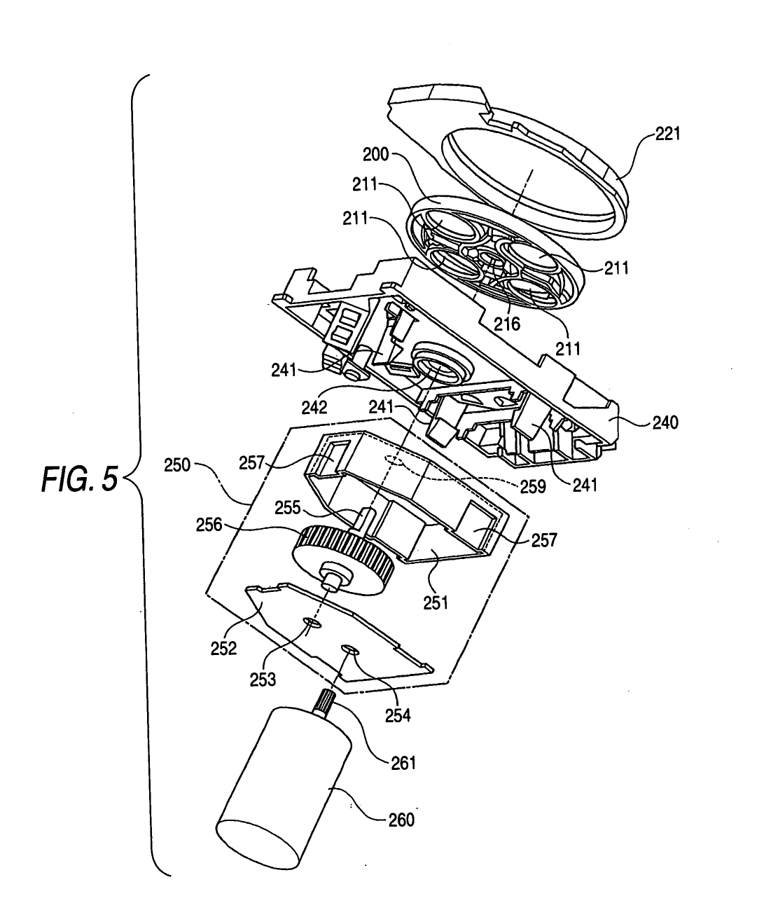

FIG. 5 is a drawing to show the detailed peripheral mechanism of the rotation disk 200. As shown in FIG. 5, the rotation disk 200 is disposed on the inside of an opening made in the center of a cover 221. The rotation shaft 255 of the driven gear 256 is press-fitted through an attachment unit 240 into a hole 216 disposed at the center of the rotation disk 200 disposed on the inside of the opening. As the rotation shaft 255 of the driven gear 256 is press-fitted into the hole 216, the rotation disk 200 is fixed. Detailed parts disposed on the rotation disk 200, such as the outer guide plate 220, are omitted.

The attachment unit 240 is provided for attaching the cover 221, the rotation disk 200, a gear unit 250 (described later), and the like with a fix member. As shown in FIG. 5, the attachment unit 240 is provided with a through opening 242 and gear unit fixing parts 241. The through opening 242 is an opening to insert the rotation shaft 255 of the driven gear 256. The rotation shaft 255 inserted into the opening is press-fitted into the hole 216 of the rotation disk 200.

The gear unit fixing parts 241 are members for fixing the gear unit 250 as they are fitted into recess parts 257 formed on a gear unit main body 251. Specifically, as shown in FIG. 5, each gear unit fixing part 241 is formed at the tip with a claw. The three claws are fitted into the recess parts 257, whereby the gear unit 250 is fixed to the attachment unit 240.

The gear unit 250 stores the driven gear 256 and the drive gear 261 so that they are placed in the appropriate positional relationship. The gear unit 250 includes the gear unit main body 251 and a side plate 252. The side plate 252 is formed with holes 253 and 254.

The hole 253 is provided for journaling the rotation shaft 255 of the driven gear 256 for rotation. At the position facing the hole 253, a hole 259 into which the rotation shaft 255 is inserted is made on one side of the gear unit main body 251. The rotation shaft 255 is journaled at one end by the hole 253 and is fixed at an opposite end to the hole 216 through the hole 259 and the through opening 242.

The hole 254 is provided for inserting the drive shaft of the motor 260 thereinto. The drive gear 261 is press-fitted into the tip of the drive shaft inserted into the hole 254. As shown in FIG. 5, the drive gear 261 is placed in the positional relationship so as to come in contact with the driven gear 256 and become concentric with the rotation shaft 255 of the driven gear 256.

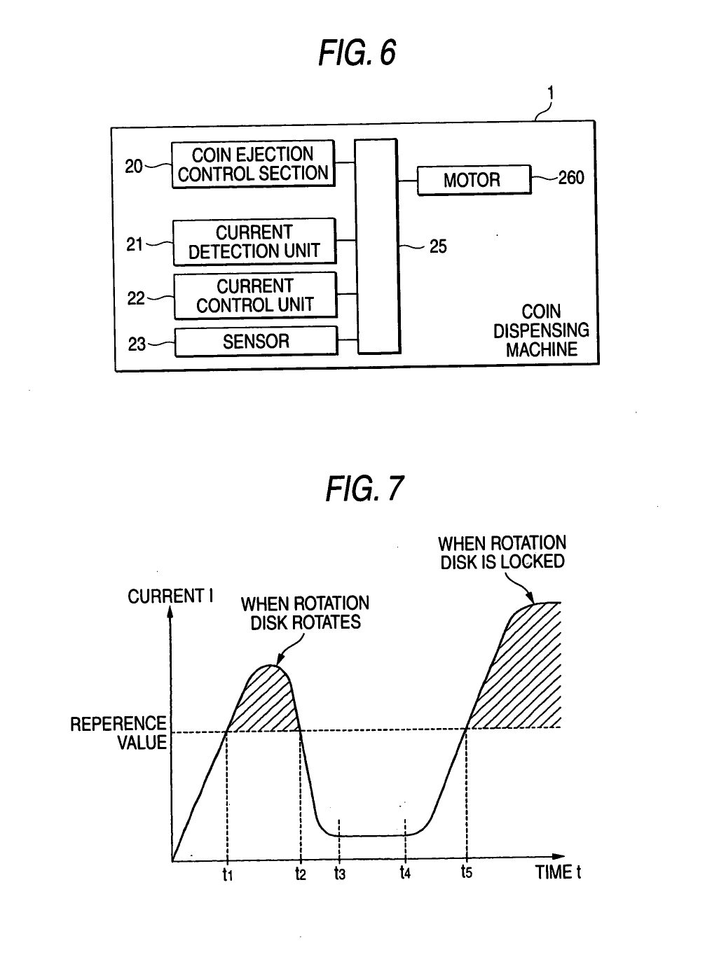

FIG. 6 is a block diagram to show the internal configuration of the coin dispensing machine 1. As shown in FIG. 6, the coin dispensing machine 1 includes a coin ejection control section 20, a current detection unit 21, a current control unit 22, a sensor 23 and the above-mentioned motor 260, which are connected by a bus 25.

The motor 260 rotates the rotation disk 200 by a control instruction from the coin ejection control section 20. The sensor 23 detects the coin 500 dispensed by the coin ejection section 230 and outputs a detection signal indicating detection of the coin to the coin ejection control section 20.

The coin ejection control section 20 controls the whole coin dispensing machine 1. Specifically, when an instruction signal for dispensing a predetermined number of coins 500 is input from a main CPU (not shown) for controlling the whole gaming machine installing the coin dispensing machine 1, the coin ejection control section 20 drives the motor 260. Accordingly, the coin ejection section 230 ejects the coins 500 one at a time from the coin ejection opening 600.

The coin ejection control section 20 also counts the number of the dispensed coins 500 in accordance with the detection signal from the sensor 23. When the count of the number of the dispensed coins reaches the predetermined number of coins, instantaneously the coin ejection control section 20 stops rotating of the motor 260.

The current detection unit 21 is a current detection unit for detecting the current flowing into the motor 260. The current detection unit 21 includes a plurality of resistors and detects the current flowing into the motor 260 based on the partial pressure ratio of the voltages imposed on the resistors.

When the current detected by the current detection unit 21 reaches a preset reference value, the current control unit 22 controls the current so that the current falls below the reference value. The current detection unit 21 and the current control unit 22 can be easily implemented using known arts (such as device of STK681) and therefore will not be discussed in detail.

FIG. 7 is a drawing to show how the current control unit 22 controls the current flowing into the motor 260. As shown in FIG. 7, a large running torque for the motor 260 to rotate the rotation disk 200 is required at the startup time of the motor 260 and thus a large current flows into the motor 260 with the passage of the time. That is, the time interval corresponding to the startup of the motor 260 is 0 to t2 and if the current control unit 22 does not control the current, the current flowing into the motor 260 becomes beyond the preset reference value between the times t1 and t2 (the left hatched portion in FIG. 7). In this case, the current control unit 22 controls the current flowing into the motor 260 so that the current falls below the reference value.

When the time interval between 0 and t2 corresponding to the startup of the motor 260 has elapsed and the time interval reaches t3 to t4, the number of revolutions of the motor 260 becomes the rated revolutions and the running torque of the motor 260 becomes the rated torque. The current flowing into the motor 260 at this time becomes a constant value less than the reference value because clogging with a coin does not occur. Then, if clogging with a coin 500 occurs and the rotation disk 200 stops at the point in time exceeding t4, a large running torque is imposed on the motor 260 and a large current flows. The current flowing into the motor 260 grows with the passage of the time and reaches the reference value at the point in time exceeding t5. In this case, the current control unit 22 controls the current flowing into the motor 260 so that the current falls below the reference value.

Preferably, the coin dispensing machine 1 has a notification unit for making a notification that the current control unit 22 controls the current so that the current falls below the reference value (for example, a sub-control circuit, a speaker, or a lamp installed in the gaming machine). In this case, the notification unit notifies the user (a player of the gaming machine, an employee or a manager of a game arcade in which the gaming machine is provided) or any other unit connected to the coin dispensing machine 1 that the current control unit 22 controls the current so that the current falls below the reference value; consequently, the notification unit can notify the user or any other unit that the rotation disk 200 stops because of clogging with a coin 500.

Hitherto, the coin dispensing machine has been unable to provide a notification indicating determination as to whether the state is (1) that the coin 500 is emptied or (2) clogging with the coin 500. In the invention, however, the notification unit notifies the user or any other unit that the current control unit 22 controls the current so that the current falls below the reference value, whereby consequently, the notification unit can provide a notification corresponding only to the state (2) and the states (1) and (2) can be discriminated from each other.

Further, when the current control unit 22 controls the detected current so that the current falls below the preset reference value, the notification unit provides a notification of the fact, whereby, for example, an employee in a gaming house including the gaming machine installing the coin dispensing machine 1 can be instantaneously and appropriately notified of the state of clogging with a coin 500, and can release the clogging with a coin instantaneously.

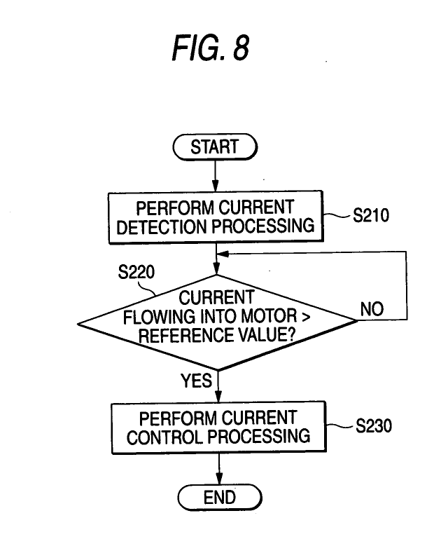

The operation of the coin dispensing machine 1 in the embodiment will be discussed with reference to FIG. 8. FIG. 8 is a flowchart to show the operation of the coin dispensing machine 1 in the embodiment.

At step 210, the current detection unit 21 detects the current flowing into the motor 260. At step 220, the current control unit 22 determines whether or not the current detected by the current detection unit 21 (current flowing into the motor 260) reaches the preset reference value. If the current is more than the preset reference value, the process goes to step 230; if the current is equal to or less than the preset reference value, step 220 is repeated. At step 230, the current control unit 22 controls the detected current so that the current falls below the preset reference value.

According to the invention, when the current detected by the current detection unit 21 reaches the preset reference value, the current control unit 22 controls the detected current so that the current falls below the reference value, whereby the coin dispensing machine 1 can prevent overcurrent from flowing into the motor 260 even at the failure time of clogging with a coin or at the startup time.

The current detection unit 21 or the current control unit 22 is not limited to the hardware configuration including resistors or diodes and may be implemented as a program that can execute the processing in the current detection unit 21 or the current control unit 22 is executed.

If the current detected by the current detection unit 21 becomes equal to or more than a constant multiple (for example, three times or more) of a preset reference current value (for example, the maximum allowable current value or the rated current value), the current control unit 22 may control the detected current so that the current falls below the reference current value.

If the current detected by the current detection unit 21 is larger than the maximum current value required for rotating the rotation disk 200 (for example, the maximum current value at the time interval between t1 and t2 shown in FIG. 7), the current control unit 22 may control the detected current so that the current falls below a preset reference current value (for example, the maximum allowable current value or the rated current value).

When the current control unit 22 controls the detected current so that the current falls below the preset reference value until the expiration of a preset reference time, the notification unit may provide a notification of the fact. For example, when the rotation disk 200 stops because of clogging with a coin 500 occurs, the current control unit 22 continues to control the detected current so that the current falls below the preset reference value. On the other hand, if clogging with a coin 500 does not occur, the current control unit 22 controls the detected current so that the current falls below the preset reference value only at the startup time of the rotation disk 200. Therefore, if the current control unit 22 continues to control the current, it means that clogging with a coin 500 occurs, and consequently the notification unit can notify, to an employee in a game arcade, that clogging with a coin 500 occurs.

As described above, the coin dispensing machine 1 according to the embodiment can prevent overcurrent from flowing into the motor even at the failure time of clogging with a coin or at the startup time.

Next, a coin dispensing machine 10 according to a second embodiment of the invention will be discussed with reference to the accompanying drawings.

Parts identical with those previously described with reference to the previous accompanying drawings in the first embodiment are denoted by the same reference numerals in the following accompanying drawings in the second embodiment and therefore will not be discussed again.

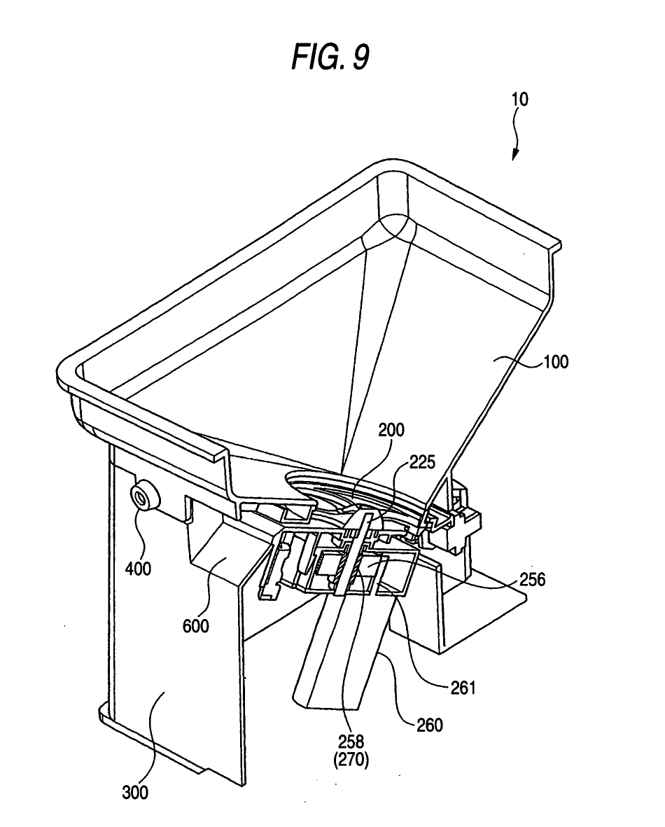

In the coin dispensing machine 10, the peripheral mechanism of a rotation disk 200 is configured as the following description. FIG. 9 is a schematic perspective view to show the cross section of the coin dispensing machine 10. As shown in FIG. 9, mainly disposed in the peripheral mechanism of the rotation disk 200 are a driven gear 256 including a rotation shaft 255 of the rotation disk 200 and a motor 260 including a drive gear 261 meshing with the driven gear 256. A torque limiter 258 and a one-way clutch 270 (described later) are built in the rotation shaft 255 of the driven gear 256 (hatched portions in FIG. 9).

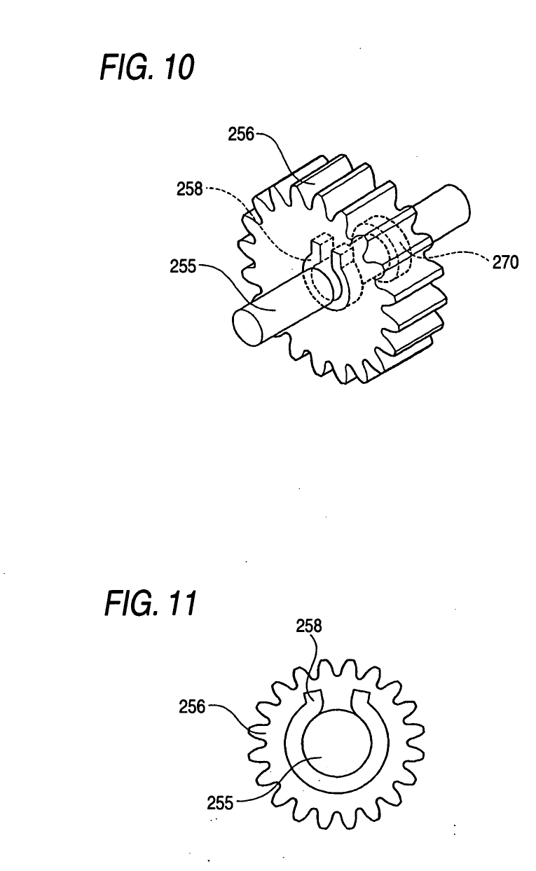

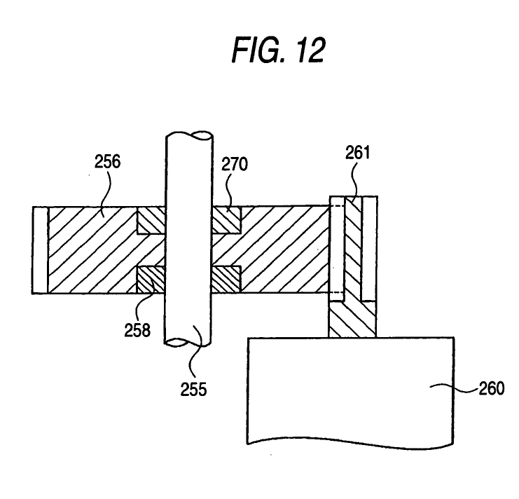

FIG. 10 is a perspective view to show the torque limiter 258. FIG. 11 is a front view of the torque limiter 258 from the axial direction of the rotation shaft 255. FIG. 12 is a drawing to show the cross sections of the torque limiter 258 and the one-way clutch 270 parallel with the rotation shaft 255. When a motor 260 rotates in a forward direction or a reverse direction, if load torque occurring between the drive shaft of the motor 260 and the rotation shaft 255 of the rotation disk 200 (or the rotation shaft 255 of the driven gear 256) exceeds a predetermined torque level, the torque limiter 258 serves as a transmission limiting unit for limiting the rotation drive force transmitted from the motor 260 to the rotation disk 200. In the embodiment, the forward direction refers to the direction in which coins 500 are dispensed (first direction), and the reverse direction refers to the direction in which coins 500 are not dispensed (second direction opposite to the first direction).

The torque limiter 258 according to the embodiment is formed integrally with the driven gear 256 for transmitting the rotation torque of the drive gear 261 to the rotation disk 200 and is press-fitted into the rotation shaft 255 of the rotation disk 200.

Specifically, as shown in FIGS. 10 to 12, the torque limiter 258 is formed on the outer periphery with the driven gear 256. Lubricating oil is sealed in space between the torque limiter 258 and the rotation shaft 255.

The drive gear 261 placed on the drive shaft of the motor 260 is in contact with the driven gear 256. Therefore, the rotation torque occurring on the drive shaft of the motor 260 is transmitted intactly to the rotation shaft 255 of the driven gear 256. If clogging with a coin 500 on the rotation disk 200 occurs and the rotation shaft 255 of the driven gear 256 is not rotated by the rotation torque occurring on the drive shaft of the motor 260, a predetermined load (load torque) is imposed between the rotation shaft 255 of the driven gear 256 and the drive shaft of the motor 260. In other words, predetermined load torque is imposed between the rotation shaft 255 of the driven gear 256 and the torque limiter 258 on which a similar force to that on the drive shaft of the motor 260 is imposed.

If the load torque occurring between the rotation shaft 255 and the torque limiter 258 does not exceed a predetermined torque level, the torque limiter 258 and the rotation shaft 255 rotate in one piece. This means that the torque limiter 258 prevents the rotation drive force transmitted from the motor 260 to the rotation disk 200 from idling.

In contrast, if the load torque occurring between the rotation shaft 255 and the torque limiter 258 exceeds the predetermined torque level, the torque limiter 258 and the rotation shaft 255 rotate separately. This means that the torque limiter 258 idles the rotation drive force transmitted from the motor 260 to the rotation disk 200.

That is, if the load torque does not exceed the predetermined torque level, the torque limiter 258 allows rotation produced from the motor 260 to be transmitted to the rotation disk 200. If the load torque exceeds the predetermined torque level, the torque limiter 258 limits the rotation drive force transmitted from the motor 260 to the rotation disk 200.

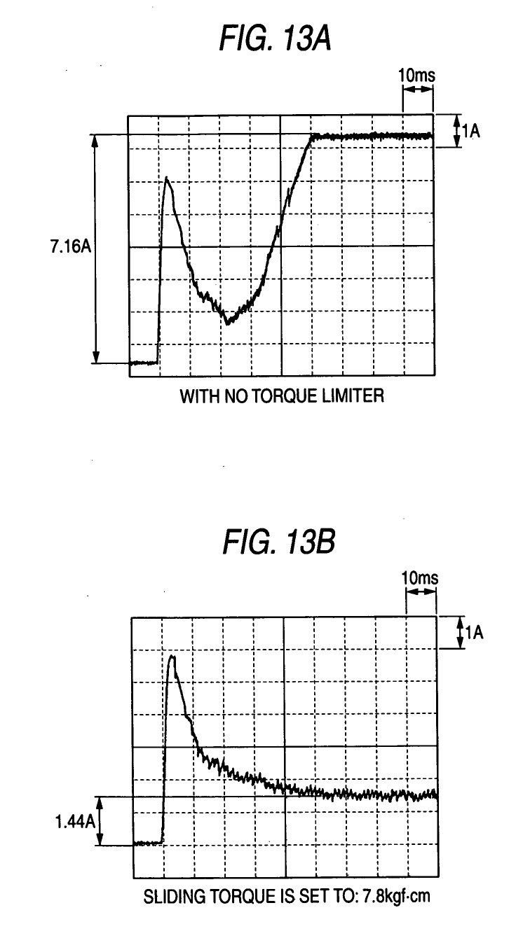

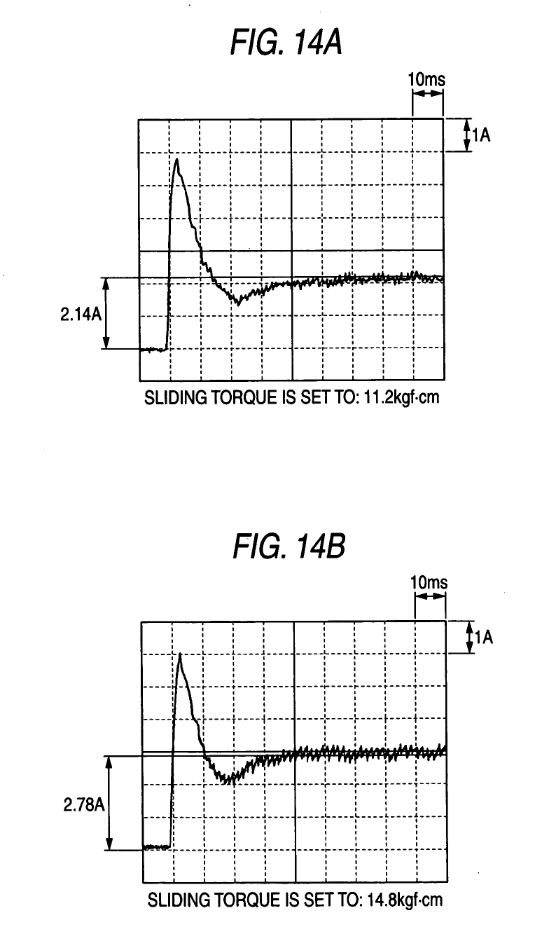

FIG. 13A is a drawing to show the current values of the motor 260 relative to the time when the rotation disk 200 is stopped (locked) because of clogging with a coin 500 (when the torque limiter 258 is not disposed). FIGS. 13B, 14A, and 14B are drawings to show the current values of the motor 260 relative to the time when the rotation disk 200 is stopped (locked) because of clogging with a coin 500 (when the torque limiter 258 is disposed).

In FIG. 13A, the current value rises to about 5.7A since clogging with a coin 500 occurred and then the current value once falls, but again rises to a stationary value (about 7.16 A). This means that overcurrent flows into the drive circuit for driving the motor 260 since rotation of the rotation disk 200 is stopped (locked) because of clogging with a coin 500.

It is seen that the stationary value (about 7.16 A) shown in FIG. 13A is obviously large as compared with the stationary values (about 1.44 A to 2.78 A) shown in FIGS. 13B, 14A, and 14B with the torque limiter 258 disposed. In other words, the stationary value provided when the torque limiter 258 is disposed (FIG. 13B, 14A, 14B) is more suppressed than that provided when the torque limiter 258 is not disposed (FIG. 13A). That is, the torque limiter 258 can lessen the load imposed on the drive shaft of the motor 260 and can also decrease the overcurrent flowing into the motor 260 when the rotation disk 200 is locked.

FIGS. 13B, 14A, and 14B are also drawings to show the current values of the motor 260 relative to the time when the setup value of sliding torque in the torque limiter 258 is increased stepwise. The setup values of the sliding torque in FIGS. 13B, 14A, and 14B are 7.8 kgf·cm, 11.2 kgf·cm, and 14.8 kgf·cm.

As seen in FIGS. 13B, 14A, and 14B, as the setup value of the sliding torque lessens (14.8 kgf cm→11.2 kgf cm→7.8 kgf cm, the stationary value of the current lessens (2.78 A→2.14 A→1.44 A). Accordingly, if the setup value of the sliding torque in the torque limiter 258 is smaller to some extent, the stationary value can be suppressed. That is, if the setup value of the sliding torque is smaller to some extent, when the rotation disk 200 is locked, the load imposed on the drive shaft of the motor 260 can be lessened and the overcurrent flowing into the motor 260 can also be decreased.

When the torque limiter 258 limits the rotation drive force transmitted from the motor 260 to the rotation disk 200 (for example, when clogging with a coin occurs), if the motor 260 is driven in the forward direction (for example, forward rotation), the one-way clutch 270 does not transmit the rotation torque of the motor 260 to the rotation disk 200; if the motor 260 is driven in the reverse direction (for example, reverse rotation), the one-way clutch 270 transmits the rotation torque of a given torque or more of the motor 260 to the rotation disk 200. That is, the one-way clutch 270 serves as a transmission switching unit. The one-way clutch 270 is disposed so as to become concentric with the rotation shaft 255 of the rotation disk 200 as shown in FIG. 10. The above-mentioned given torque in the embodiment means the maximum load torque imposed between the torque limiter 258 and the rotation shaft 255 before the torque limiter 258 idles.

Specifically, when clogging with a coin 500 occurs, the motor 260 is driven in the reverse direction according to an instruction from a coin ejection control section. When the motor 260 is rotated in the reverse direction, the one-way clutch 270 locks the rotation shaft 255 of the rotation disk 200 and rotates integrally with the rotation shaft 255 in conjunction with rotation of the driven gear 256, transmitting the rotation torque of the motor 260 to the rotation disk 200. Accordingly, the one-way clutch 270 can release the clogging with the coin 500. The detailed operation of the one-way clutch 270 will be described hereinafter. (1) In a Case where Load Torque is Below Predetermined Torque Level

In a case where the load torque is below a predetermined torque level, the torque limiter 258 does not idle regardless of whether the motor 260 rotates in the forward or reverse direction and thus the rotation drive of the motor 260 is transmitted intactly to the rotation shaft 255 of the rotation disk 200. At this time, the one-way clutch 270 rotates together with the driven gear 256 at the same speed and therefore the rotation difference between the one-way clutch 270 and the rotation shaft 255 of the rotation disk 200 is zero.

That is, the one-way clutch 270 does not idle and does not lock the rotation shaft 255 of the rotation disk 200 (does not transmit the rotation torque of the motor 260). In other words, the one-way clutch 270 remains in the state when rotation drive of the rotation disk 200 is started.

The one-way clutch 270 does not lock the rotation shaft 255 of the rotation disk 200 until the one-way clutch 270 rotates the rotation shaft 255 minutely in the lock direction from the release state in which the rotation shaft 255 of the rotation disk 200 is not locked. On the other hand, when the rotation shaft 255 of the rotation disk 200 is locked, the one-way clutch 270 rotates the rotation shaft 255 minutely in the direction of placing the release state, thereby releasing locking of the rotation shaft 255. (2) In a Case where Load Torque Exceeds Predetermined Torque Level

In a case where the load torque exceeds the predetermined torque level, the torque limiter 258 idles and thus a speed difference occurs between the one-way clutch 270 rotating together with the driven gear 256 and the rotation shaft 255 of the rotation disk 200 limited in drive rotation by the effect of the torque limiter 258. The one-way clutch 270 then enters the release state or locks the rotation shaft 255 of the rotation disk 200 depending on whether the motor 260 rotates in the forward or reverse direction based on the speed difference.

That is, when the motor 260 rotates in the forward direction (the direction in which coins 500 are dispensed), the speed difference occurs between the one-way clutch 270 and the rotation shaft 255 of the rotation disk 200 in the direction of placing the one-way clutch 270 in the release state, so that the one-way clutch 270 remains in the release state or releases locking of the rotation shaft 255. Therefore, the one-way clutch 270 does not transmit the rotation drive of the motor 260 to the rotation shaft 255 of the rotation disk 200.

On the other hand, when the motor 260 rotates in the reverse direction (the direction in which coins 500 are not dispensed), the speed difference occurs between the one-way clutch 270 and the rotation shaft 255 of the rotation disk 200 in the direction in which the one-way clutch 270 locks the rotation shaft 255, so that the one-way clutch 270 remains locking the rotation shaft 255 or first locks the rotation shaft 255. Therefore, the one-way clutch 270 transmits the rotation drive of the motor 260 to the rotation shaft 255 of the rotation disk 200.

According to the embodiment, when the motor 260 rotates in the forward or reverse direction, if the load torque occurring between the drive shaft of the motor 260 and the rotation shaft 255 of the rotation disk 200 exceeds the predetermined torque level, the torque limiter 258 limits the rotation drive force transmitted from the motor 260 to the rotation disk 200, whereby the coin dispensing machine 10 prevents excessive load from being imposed on the motor 260 when clogging with a coin occurs, so that overcurrent can be prevented from flowing into the motor 260.

Excessive load can be prevented from being imposed on the drive shaft of the motor 260, so that it is made possible to adopt a molded article, etc., of low strength for the drive system of the motor 260 (for example, the drive gear 261). Consequently, the cost of the drive system can be decreased.

When the torque limiter 258 limits the rotation torque of the motor 260 (when clogging with a coin occurs), if the motor rotates in the reverse direction, the one-way clutch 270 transmits the rotation torque of the given torque or more to the rotation disk 200 without idling the rotation disk 200, whereby when clogging with a coin occurs, the coin dispensing machine can release the clogging with the coin.

The example wherein the torque limiter 258 and the one-way clutch 270 are disposed on the rotation shaft 255 of the rotation disk 200 is described above. However, for example, the torque limiter 258 and the one-way clutch 270 may be disposed anywhere if they are disposed between the drive shaft of the motor 260 and the rotation shaft 255 of the rotation disk 200. If a plurality of intermediate gears (for example, idle gears) are built in between the drive shaft of the motor 260 and the rotation shaft 255 of the rotation disk 200, the torque limiter 258 and the one-way clutch 270 may be disposed on any of the intermediate gears.

As described above, according to the embodiment, when the rotation disk stops because of clogging with a coin, a large load is prevented from being imposed on the motor, whereby overcurrent can be prevented from flowing into the motor and the clogging with the coin can also be released.

In the first embodiment, the current detection unit 21 and the current control unit 22 are provided as an example of overload preventing device for preventing excessive load from being imposed on the drive unit. In the second embodiment, the torque limiter 258 is provided as an example of overload preventing device. However, the invention is not limited to the configuration illustrated in the first or second embodiment, and the overload preventing device can be implemented using any of various mechanisms and electronic circuits in combination.

In the second embodiment, the configuration in which the torque limiter 258 is included as the transmission limiting unit is illustrated; however, the transmission limiting unit may be implemented using other members and mechanisms in appropriate combination if it is configured so as to limit the rotation drive force transmitted from the drive unit to the rotation disk when the load torque occurring between the drive shaft of the drive unit and the rotation shaft of the rotation disk exceeds the predetermined torque level For example, the transmission limiting unit may be implemented by appropriately designing a control circuit for controlling the drive unit (motor 260 and drive system).

In the second embodiment, the configuration in which the one-way clutch 270 is included as the transmission switching unit is illustrated; however, the transmission switching unit may be implemented using other members and mechanisms in appropriate combination if it is configured so as not to transmit the rotation drive force to the rotation disk when the drive unit drives the rotation disk in the first direction in which coins are dispensed and so as to transmit the rotation drive force to the rotation disk when the drive unit drives the rotation disk in the second direction opposite to the first direction under the state in which the transmission limiting unit limits the rotation drive force. For example, the transmission switching unit may be implemented by appropriately designing a control circuit for controlling the drive unit (motor 260 and drive system).

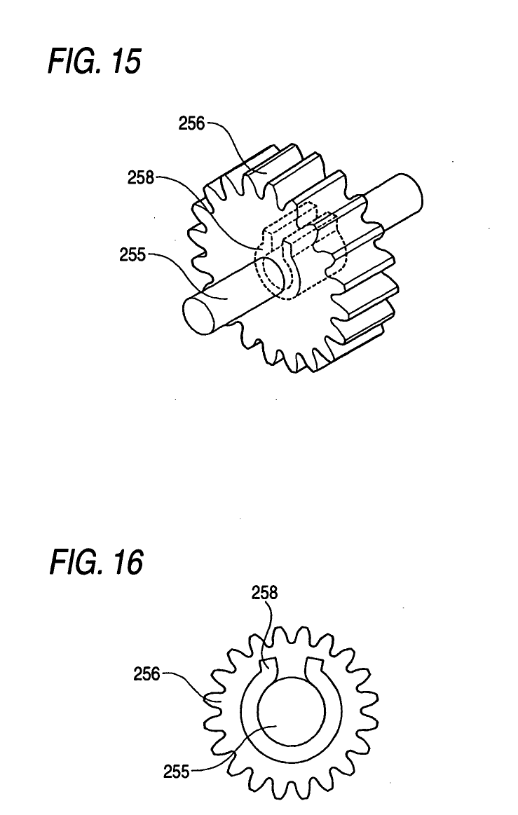

In the second embodiment, the coin dispensing machine 10 includes both the torque limiter 258 and the one-way clutch 270 by way of example. However, for example, only one of the torque limiter 258 and the one-way clutch 270 may be disposed in the coin dispensing machine 10. FIGS. 15 and 16 show a configuration example of the rotation shaft 255 of the rotation disk 200 when the one-way clutch 270 is not disposed in the coin dispensing machine 10.

As shown in FIGS. 15 and 16, if the one-way clutch 270 is not disposed on the rotation shaft 255, the torque limiter 258 can prevent excessive load from being imposed on the motor 260 for preventing overcurrent from flowing into the motor 260.

To configure the coin dispensing machine, any of the current detection unit 21 and the current control unit 22 described in the first embodiment and the torque limiter 258 and the one-way clutch 270 described in the second embodiment may be used in combination.

A configuration-will be discussed wherein the current detection unit 21 and the current control unit 22 described in the first embodiment and the torque limiter 258 described in the second embodiment are used in combination. In this case, the coin dispensing machine is configured so that the torque limiter 258 limits the rotation drive force transmitted by the drive system if the load imposed on the drive system is smaller than the load produced in the drive system when the current detection unit 21 and the current control unit 22 start to limit the current supplied to the motor 260.

The coin dispensing machine thus configured is applied with both (a) the overload prevention based on an electrical control by the current detection unit 21 and the current control unit 22 and (b) the overload prevention based on an mechanical control by the torque limiter 258, and is configured to start the limitation by the mechanical control at a lower load than a load in which the limitation by the electrical control is started.

According to the configuration, the torque limiter 258 can prevent excessive load from being imposed on the motor 260 when clogging with a coin occurs, and the possibility that a current more than the rated current will be supplied to the motor 260 for any other reason than the clogging with a coin (such as an anomaly in the drive circuit, and mechanical deterioration of the torque limiter 258) can be eliminated.

Incidentally, it may also be configured so as to start the limitation by the electrical control at a lower load than a load in which the limitation by the mechanical control is started.

As described above, according to a first configuration of the invention, there is provided a payment object dispensing machine, including a bucket (for example, bucket 100) that stores a plurality of payment objects (for example, coins 500); a rotation disk (for example, rotation disk 200) being placed on a bottom of the bucket and formed with a plurality of openings for accepting the payment objects; a drive unit (for example, motor 260, driven gear 256, etc.) that dispenses the payment objects accepted in the openings sequentially by rotating the rotation disk; and an overload preventing device (for example, current detection unit 21, current control unit 22, torque limiter 258) that prevents excessive load from being imposed on the drive unit.

According to the first configuration of the invention, the overload preventing device is provided, so that the coin dispensing machine can prevent excessive load from being imposed on the drive unit even at the failure time of clogging with a coin or at the startup time.

The overload preventing device may include a current detection unit that detects current supplied to the drive unit; and a current control unit that controls the current supplied to the drive unit so that the current falls below a preset reference value if the current detected by the current detection unit reaches the preset reference value. According to the configuration, the payment object dispensing machine can prevent overcurrent from flowing into the motor even at the failure time of clogging with a payment object or at the startup time.

The payment object dispensing machine may further include a notification unit (for example, a sub-control circuit, a speaker, a lamp, or the like installed in the gaming machine installing the coin dispensing machine) that outputs a notification to a user when the current control unit is controlling the current supplied to the drive unit to fall below the reference value. According to the configuration, the notification unit can notify the user or any other unit connected to the coin dispensing machine that the rotation disk stops because of clogging with a payment object.

Hitherto, a conventional payment object dispensing machine has been unable to provide a notification indicating determination as to whether the state is (1) that the payment object is empty or (2) clogging with the payment object. However, the notification unit according to the present invention can notify the user or any other unit that the current is limited so that the current value falls below the reference value, so that a notification corresponding only to the state (2) can be provided and the states (1) and (2) can be discriminated from each other.

If the current detected by the current detection unit becomes equal to or more than a constant multiple (for example, three times or more) of a preset reference current value (for example, the maximum allowable current value or the rated current value), the current control unit may control the detected current so that the current falls below the reference current value.

If the current detected by the current detection unit is larger than the maximum-current value required for rotating the rotation disk (for example, the maximum current value at the time interval between t1 and t2 shown in FIG. 7), the current control unit may control the detected current so that the current falls below the preset reference current value (for example, the maximum allowable current value or the rated current value).

When the current control unit controls the detected current so that the current falls below the preset reference value until the expiration of a preset reference time, the notification unit may provide a notification of the fact.

The overload preventing device may include a transmission limiting unit (for example, torque limiter 258) that limits rotation drive force transmitted from the drive unit to the rotation disk if load torque occurring between a drive shaft of the drive unit and a rotation shaft of the rotation disk exceeds a predetermined torque level. According to the configuration, the payment object dispensing machine can prevent excessive load from being imposed on the motor when the rotation disk stops because of clogging with a payment object, thereby preventing overcurrent from flowing into the motor.

That is, if the load torque occurring between the drive shaft of the drive unit and the rotation shaft of the rotation disk exceeds the predetermined torque level, the transmission limiting unit idles the rotation drive force transmitted from the drive unit to the rotation disk. As the rotation idles, load is not much imposed on the drive shaft of the drive unit (motor) Since load is not much imposed on the drive shaft of the motor, the overcurrent flowing into the motor is decreased.

The transmission limiting unit may be placed anywhere if it is placed between the drive shaft of the drive unit and the rotation shaft of the rotation disk. If a plurality of intermediate gears (for example, idle gears) are built in between the drive shaft of the drive unit and the rotation shaft of the rotation disk, the transmission limiting unit may be disposed on any of the intermediate gears. Further, the transmission limiting unit may be built in the driven gear for transmitting the rotation of the drive unit to the rotation disk and may be fitted into the rotation shaft of the rotation disk.

The overload preventing device may further include a transmission switching unit (for example, one-way clutch 270) that suppresses transmission of the rotation drive force to the rotation disk when the drive unit drives the rotation disk in the first direction in which payment objects are dispensed and transmits the rotation drive force to the rotation disk when the drive unit drives the rotation disk in the second direction opposite to the first direction under the state in which the transmission limiting unit limits the rotation drive force.

According to the configuration, in the payment object dispensing machine, when the drive unit drives the rotation disk in the first direction, if the load torque occurring between the drive shaft of-the drive unit and the rotation shaft of the rotation disk exceeds the predetermined torque level, the transmission limiting unit limits the rotation drive force transmitted from the drive unit to the rotation disk; when the transmission limiting unit limits the rotation torque of the drive unit, if the drive unit drives the rotation disk in the second direction, the transmission switching unit transmits the rotation torque of the given torque or more to the rotation disk. Thus, the payment object dispensing machine can prevent excessive load from being imposed on the motor, thereby preventing overcurrent from flowing into the motor, and can also release the clogging with a payment object.

The transmission limiting unit and the transmission switching unit may be placed anywhere if they are placed between the drive shaft of the drive unit and the rotation shaft of the rotation disk. If a plurality of intermediate gears (for example, idle gears) are built in between the drive shaft of the drive unit and the rotation shaft of the rotation disk, the transmission limiting unit and the transmission switching unit may be disposed on any of the intermediate gears. Further, the transmission limiting unit may be built in the driven gear for transmitting the rotation of the drive unit to the rotation disk and may be press-fitted into the rotation shaft of the rotation disk.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable those skilled in the art to utilize the invention in various embodiments and with various modifications as are suited to the particular use contemplated. It is intended that the scope of the invention be defined by the claims appended hereto, and their equivalents.

1. A payment object dispensing machine comprising:
a bucket that stores a plurality of payment objects;
a rotation disk being placed on a bottom of the bucket and formed with a plurality of openings for accepting the payment objects;
a drive unit that dispenses the payment objects accepted in the openings sequentially by rotating the rotation disk; and
an overload preventing device that prevents excessive load from being imposed on the drive unit.

2. The payment object dispensing machine as claimed in claim 1, wherein the overload preventing device comprises:
a current detection unit that detects current supplied to the drive unit; and
a current control unit that controls the current so that the current falls below a preset reference value when the current reaches the preset reference value.

3. The payment object dispensing machine as claimed in claim 2 further comprising a notification unit that outputs a notification to a user when the current control unit is controlling the current to fall below the reference value.

4. The payment object dispensing machine as claimed in claim 2, wherein the overload preventing device comprises a transmission limiting unit that limits rotation drive force transmitted from the drive unit to the rotation disk when load torque occurring between a drive shaft of the drive unit and a rotation shaft of the rotation disk exceeds a predetermined torque level.

5. The payment object dispensing machine as claimed in claim 4, wherein the drive unit comprises a driven gear that transmits the rotation drive force to the rotation disk, and
wherein the transmission limiting unit is built in the driven gear.

6. The payment object dispensing machine as claimed in claim 5, wherein the transmission limiting unit is formed integrally with the driven gear and is fitted into the rotation shaft of the rotation disk.

7. The payment object dispensing machine as claimed in claim 4, wherein the transmission limiting unit comprises a torque limiter.

8. The payment object dispensing machine as claimed in claim 4, wherein the overload preventing device further comprises a transmission switching unit that suppresses transmission of the rotation drive force to the rotation disk when the drive unit rotates the rotation disk in a first direction in which the payment object is dispensed, and transmits the rotation drive force to the rotation disk when the drive unit rotates the rotation disk in a second direction opposite to the first direction under a state in which the transmission limiting unit limits the rotation drive force.

9. The payment object dispensing machine as claimed in claim 8, wherein the transmission switching unit comprises a one-way clutch.

10. The payment object dispensing machine as claimed in claim 1, wherein the overload preventing device comprises a transmission limiting unit that limits rotation drive force transmitted from the drive unit to the rotation disk when load torque occurring between a drive shaft of the drive unit and a rotation shaft of the rotation disk exceeds a predetermined torque level.

11. The payment object dispensing machine as claimed in claim 10, wherein the drive unit comprises a driven gear that transmits the rotation drive force to the rotation disk, and
wherein the transmission limiting unit is built in the driven gear.

12. The payment object dispensing machine as claimed in claim 11, wherein the transmission limiting unit is formed integrally with the driven gear and is fitted into the rotation shaft of the rotation disk.

13. The payment object dispensing machine as claimed in claim 10, wherein the transmission limiting unit comprises a torque limiter.

14. The payment object dispensing machine as claimed in claim 10, wherein the overload preventing device further comprises a transmission switching unit that suppresses transmission of the rotation drive force to the rotation disk when the drive unit rotates the rotation disk in a first direction in which the payment object is dispensed, and transmits the rotation drive force to the rotation disk when the drive unit rotates the rotation disk in a second direction opposite to the first direction under a state in which the transmission limiting unit limits the rotation drive force.

15. The payment object dispensing machine as claimed in claim, 14, wherein the transmission switching unit comprises a one-way clutch.

16. A payment object dispensing machine comprising:
storage means for storing a plurality of payment objects;
rotation disk means being placed on a bottom of the storage means and formed with a plurality of openings for accepting the payment objects;
drive means for dispensing the payment objects accepted in the openings sequentially by rotating the rotation disk; and
overload preventing means for preventing excessive load from being imposed on the drive means.
